(19) United States
(12) Patent Application Publication
(10) Pub. No.: US 2024/0053958 A1
(43) Pub. Date: Feb. 15, 2024

(54) METHOD OF MULTIPLE SEQUENCE ALIGNMENT USING CONTINUOUS POSITION SOLVING AND QUANTIZATION WITH BEAD-ATTRACTION MODEL

(71) Applicant: Daniel Kim, Chappaqua, NY (US)

(72) Inventor: Daniel Kim, Chappaqua, NY (US)

(21) Appl. No.: 18/468,420

(22) Filed: Sep. 15, 2023

(51) Int. Cl. G06F 7/24; G06F 17/11

(52) U.S. Cl. CPC G06F 7/24; G06F 17/11

(57) ABSTRACT

Embodiments of the invention are directed to a method for aligning multiple sequences that models each sequence as a rod with interacting beads. The method begins by mapping each of the input sequences to a set of 1-dimensional coordinates that represent positions of beads. The method also defines attractive and repulsive interactions among beads on same or different sequences. In a non-limiting example of the method, steady-state coordinates that balance interacting forces or momentum can be obtained by updating coordinates in a small step. The solved steady-state coordinates are not integer numbers but decimal numbers. Finally, a quantization process is performed to convert the final coordinates into integer values and eventually into output sequences or alignment results.

### BACKGROUND

The present invention relates to a method of aligning multiple sequences, wherein each sequence is composed of a set of predefined symbols. Examples of such sequences exist in biology through DNA and RNA, which store sequential genetic information wherein the symbols are nitrogenous bases, and in natural language, wherein the symbols are letters or words.

In fields such as bioinformatics, sequences are often compared to identify regions of similarity that may indicate functional, structural, or evolutionary relationships between the sequences. For proper comparison, sequences should first be properly aligned. The alignment involves more than just shifting one sequence versus others; it also requires inserting gaps into the sequences to compensate for indels (insertion or deletion of one or more bases).

Several different methods to find an optimal or near-optimal alignment of two or more sequences have been developed. They include dynamic programming, progressive, and iterative methods. Conventional methods have a trade-off between an alignment's accuracy and the cost of its computation—i.e., computing time and computing resources such as memory capacity. The computing cost increases dramatically as either the sequence length or the number of sequences increases.

In conventional alignment methods, alignments are adjusted for individual sequences one at a time or on a pair-wise basis, which makes multiple sequence alignment (MSA) inefficient and challenging. Different interim alignments may be tried and searched in a combinatorial manner, but it is almost impossible to search across all the possible combinations. When the number of sequences increases, alignments have relied on more and more on approximation so that the procedure can complete in a reasonable time, undermining alignment accuracy.

In this invention, a multiple sequence alignment (MSA) method is described in which alignments of all the sequences are adjusted concurrently so that the quality of alignment is maximized spontaneously in a single convergence process while avoiding an exhaustive, time-consuming search across combinatorial space of possible alignments.

### SUMMARY

Embodiments of the invention are directed to a method for aligning multiple sequences that models a sequence as beads. The method begins with mapping each of the input sequences into a set of 1-dimensional coordinates that represent the sequential positions of the beads. The method also defines attractive and repulsive interactions among beads within or across sequences. In a non-limiting example of the method, steady-state coordinates that balance interacting forces or momentum can be obtained by updating coordinates using a small step size. The solved steady-state coordinates are not integer numbers but decimal numbers. Finally, a quantization process is performed to convert the final coordinates into integer values and eventually into output sequences or alignment results.

Additional technical features and benefits are provided by the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts an example of the mapping step from two input sequences to a bead model based on the invention;

FIG. 2A depicts an exemplary intra-sequence interaction relationship between beads;

FIG. 2B depicts another exemplary intra-sequence interaction relationship between beads;

FIG. 3A depicts an exemplary inter-sequence interaction relationship between beads;

FIG. 3B depicts another exemplary inter-sequence interaction relationship between beads;

FIG. 4 depicts a system of equations to solve bead positions based on one embodiment of the invention using a mechanics force model;

FIG. 5 depicts a system of equations to solve bead positions based on another embodiment of the invention using a mechanics velocity model;

FIG. 6 depicts an example of waveforms showing transient bead position changes based on one embodiment of the invention;

FIG. 7 depicts an example of the mapping step from a solved bead model to the output sequences based on the invention;

FIG. 8 depicts an example of the mapping step from four input sequences to a bead model based on the invention;

FIG. 9 depicts an example of the mapping step from a solved bead model corresponding to FIG. 8 to the output sequences based on the invention;

FIG. 10 depicts an exemplary quantization procedure to map the solved bead model into output sequences based on the invention;

FIG. 11 shows several different possible groupings of beads for quantization. This figure is to supplement the explanation of another embodiment of the quantization method based on the invention;

FIG. 12 depicts a flow chart that shows one embodiment of the entire procedure of multiple sequence alignment based on the invention;

FIG. 13 depicts a flow chart that shows another embodiment of the entire procedure of multiple sequence alignment based on the invention;

In the accompanying figures and following detailed description of the described embodiments of the invention, the various elements illustrated in the figures are provided with two to four-digit reference numbers. With minor exceptions, the leftmost digit(s) of each reference number correspond to the figure in which its element is first illustrated.

### DETAILED DESCRIPTION

The term “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

It is understood in advance that although exemplary embodiments of the invention are described in connection with DNA (deoxyribonucleic acid), embodiments of the invention are not limited to the types of sequences described in this specification. Rather, embodiments of the present invention are capable of being implemented in conjunction with any other type of genetic or biological sequence including but not limited to RNA (ribonucleic acid) or proteins, or non-biological sequences such as natural language or financial data.

For the sake of brevity, conventional techniques related to sequence alignment may not be described in detail herein. Moreover, the various tasks and process steps described herein can be incorporated into a more comprehensive procedure or process having additional steps or functionality not described in detail herein. Various steps in sequence extraction, alignment scoring, computer modeling and simulation are well known, so, in the interest of brevity, many conventional steps will only be mentioned briefly herein or will be omitted entirely without providing their well-known details.

Turning now to an overview of the aspects of the present invention, one or more embodiments of the invention address the aforementioned shortcomings by the following:
1) All bases (beads) in all sequences are updated concurrently in each step. Although the amount of update at each step should be small enough, thus requiring many steps, to guarantee convergence, this concurrent update significantly reduces the total required alignment time especially for large numbers of sequences.
2) Changes in bead positions each step are smaller than one base length throughout the process. This makes the score surface smooth enough so that the bead positions can gradually converge to optimum points.
3) After the bead positions converge to certain optimum points, quantization is executed to convert the continuous coordinates into integer values from which the aligned output sequences can be derived.

In conventional sequence alignment methods, the bases are allowed to be located only on integer grids. In other words, the positions of the bases are discretized or quantized. This might make sense in terms of biological evolution because real nucleotides are stored, read, and possibly mutated as whole molecules as part of discrete sequences. However, intermediate states need not adhere to real-world behavior.

Such a restriction is eliminated in this invention, and it is allowed that the positions or coordinates of each base can have any continuous value during the search. And the continuous coordinate values will be sampled and quantized at the end of the final step to be converted into real-world sequences.

This allows transforming multiple sequence alignments (MSA) from a combinatorial problem to a real-valued problem. In this invention, the optimum alignment solution is achieved by solving a system of force (or velocity) equations, where the solution is the condition that balances multiple forces (or velocities) that represent the reward or cost of each of match, mismatch and indel (insertion or deletion) of bases.

Whereas the reward and cost of match/mismatch/indel among bases in multiple sequences are assigned fixed numbers (e.g., +2, −1 and −2), they are represented by distance-dependent continuous functions in this invention. The balancing points are the solutions to the system of force (or velocity) equations that can be solved by numerical methods.

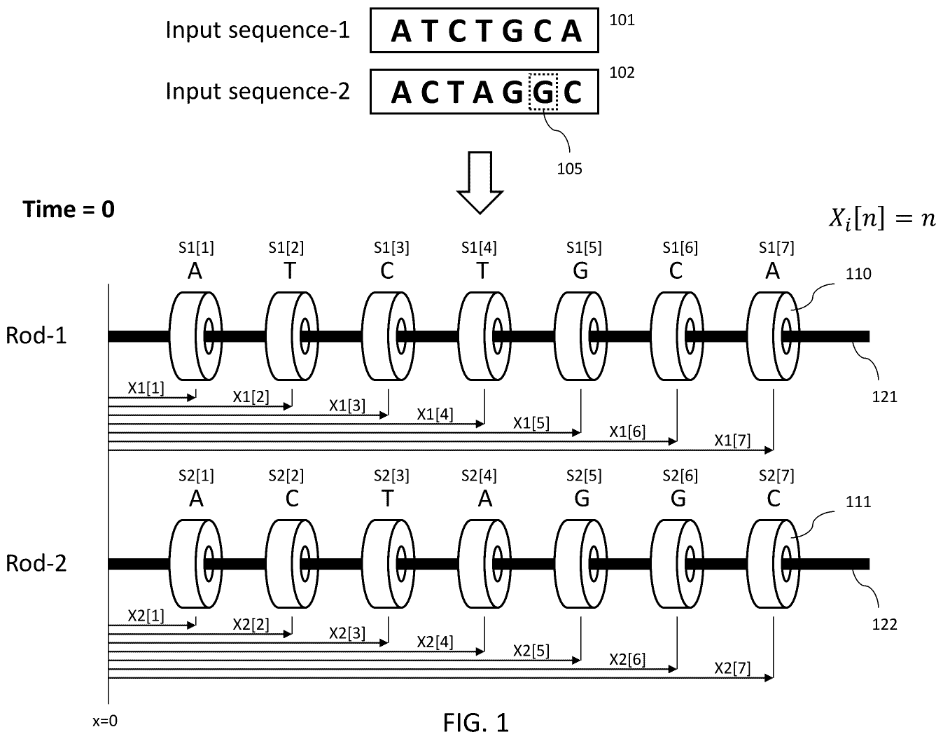

Turning now to a more detailed description of the method according to aspects of the invention, FIG. 1 depicts an example of a mapping step from two input sequences to a bead model based on the invention. Two sequences 101 and 102 are to be aligned. Each sequence is composed of 7 nucleotide bases for instance 105 is one of the bases.

Each sequence is modeled as a rod with 7 beads. Each bead represents one base. Initially (time=0), beads are placed uniformly on the rods. After time=0, beads can move in the horizontal direction, but not vertically.

Each bead is labeled with the same symbol as the symbol at the corresponding position in the original sequence. In the case of DNA sequences, there can be four different symbols: ‘A’ (adenine), ‘C’ (cytosine), ‘G’ (guanine), and ‘T’ (thymine).

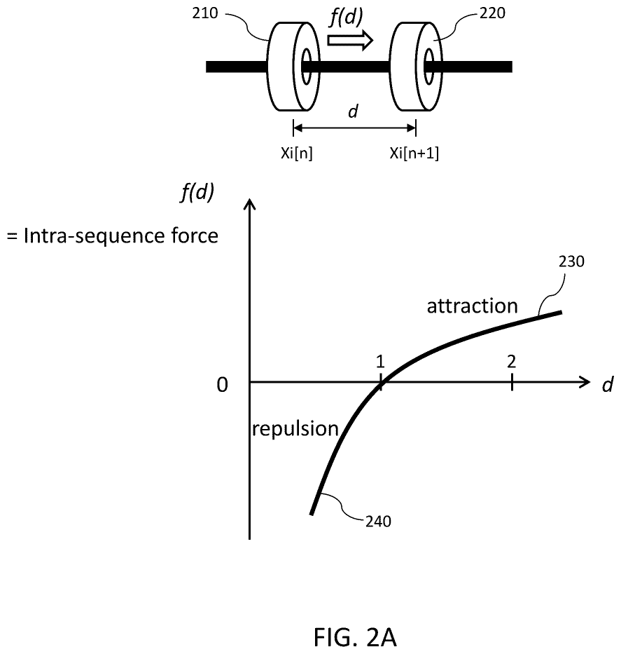

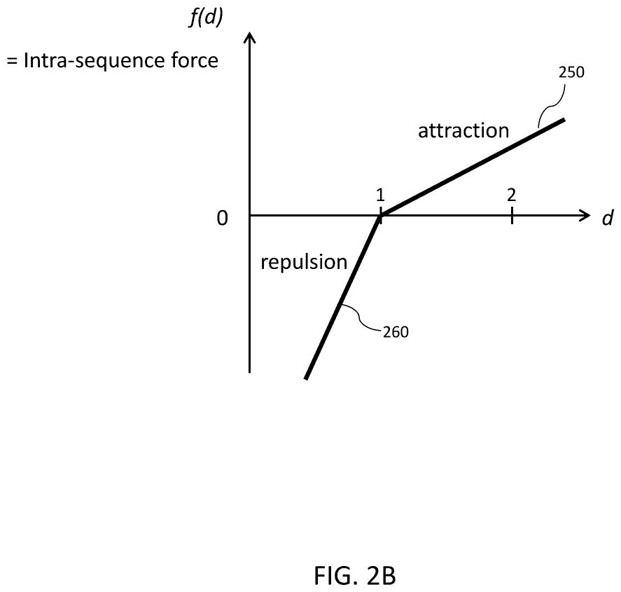

FIG. 2A depicts an exemplary intra-sequence interaction relationship between beads on the same rod (same sequence). In one embodiment, a bead will be interacting with only two neighboring beads to its left and right. When the distance between two adjacent beads becomes closer than the default distance of ‘1’, each bead will experience a repulsive force. When the distance between two adjacent beads becomes farther than ‘1’, each bead will attract each other. The curve is an exemplary nonlinear force relationship and shows the force that Xᵢ[n] feels as a result of interacting with Xᵢ₊₁[n] versus the distance between Xᵢ[n] and Xᵢ₊₁[n]. When the force is directed to the right, then its sign is defined as positive.

The repulsive intra-sequence force (230) represents the resistance between two adjacent beads to keep them a certain distance apart. The attractive intra-sequence force (240) represents the resistance to create a gap between two beads. However, this attractive resistance (240) may be modeled more weakly compared to the repulsive force (230) to allow a certain gap during the alignment process depending on other forces.

FIG. 2B depicts another exemplary intra-sequence interaction relationship between beads. The force has a piece-wise linear shape, and the slope between repulsive (260) and attractive (250) forces are modeled differently, meaning it has weaker attraction than repulsion as sometimes the distance between two adjacent beads may become as far as a few base units if appropriate forces are applied to model insertion.

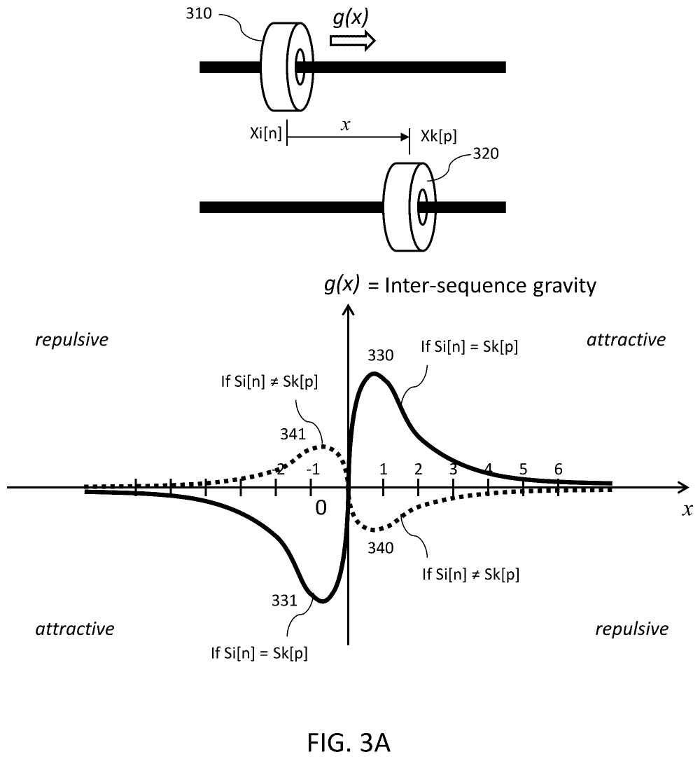

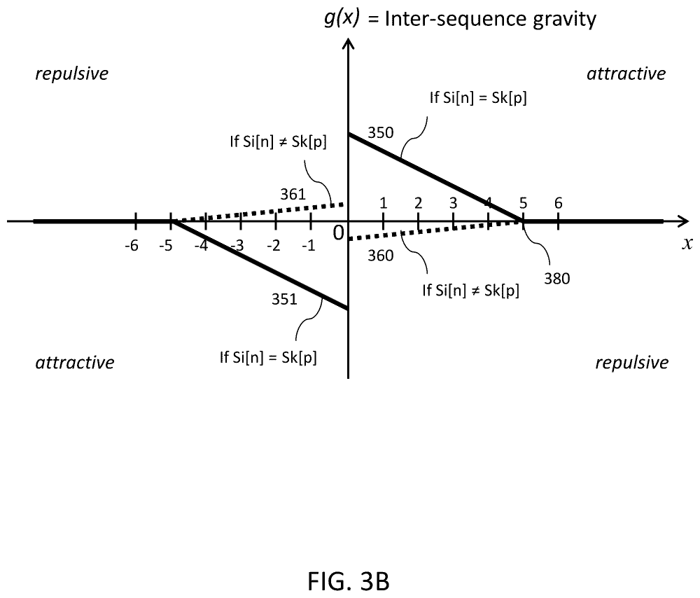

FIG. 3A depicts an exemplary inter-sequence interaction relationship between beads on different rods (different sequences). When symbols between two beads are the same (e.g., ‘A’ and ‘A’), then the two beads attract each other. The graph shows an exemplifying curve shape of the force. The curve is an exemplary nonlinear force relationship and shows the force that Xᵢ[n] feels due to interactions with Xᵢ₊₁[n] versus the position of Xᵢ₊₁[n] relative to Xᵢ[n]. Like the gravity, this inter-sequence force is modeled to become weaker as distance increases. When the force is directed to the right, its sign is defined as positive. The inter-sequence force is applied to any pair of beads in any two rods.

In one embodiment, the inter-sequence force is only an attractive force (330, 331) between two beads with like labels. In another embodiment, there can also be a repulsive force (340, 341) between two differently labeled beads.

FIG. 3B depicts another exemplary inter-sequence interaction relationship between beads. The force has a piece-wise linear shape. The force is modeled to be zero beyond some threshold of distance (380) (5′ in this example). This can limit the scope of the gravity and thus reduce the computational load during simulation.

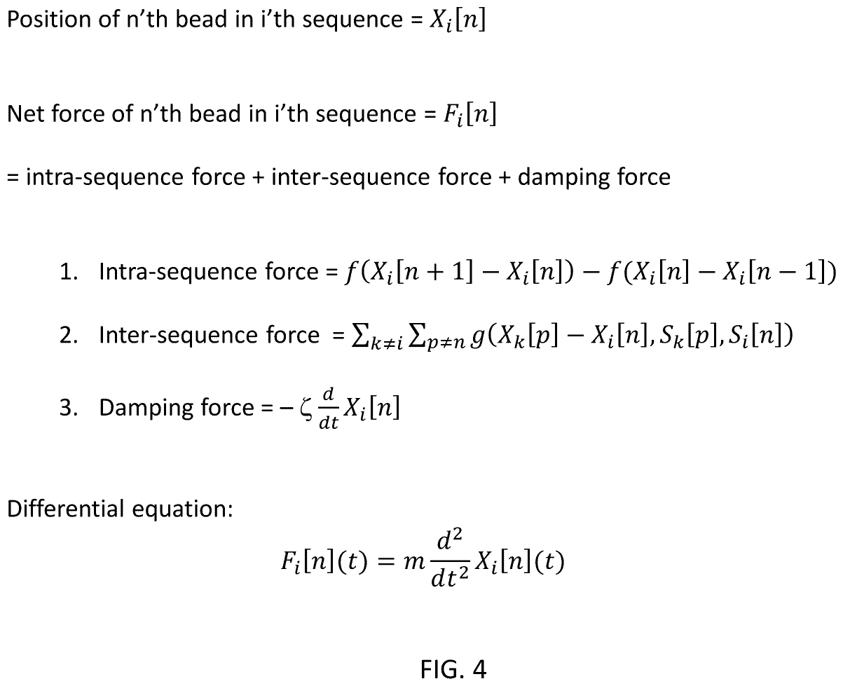

FIG. 4 depicts a system of equations to solve bead positions based on one embodiment of the invention using a mechanics system model based on F=Ma, where M represents mass. The force ‘F’ is composed of three different kinds—an intra-sequence force, an inter-sequence force, and a damping force. The damping (or friction) force is added to prevent oscillation of the movement where ζ represents the damping factor. There will be one equation per bead. This system of 2^{nd} derivative nonlinear equations can be solved approximately in various known ways.

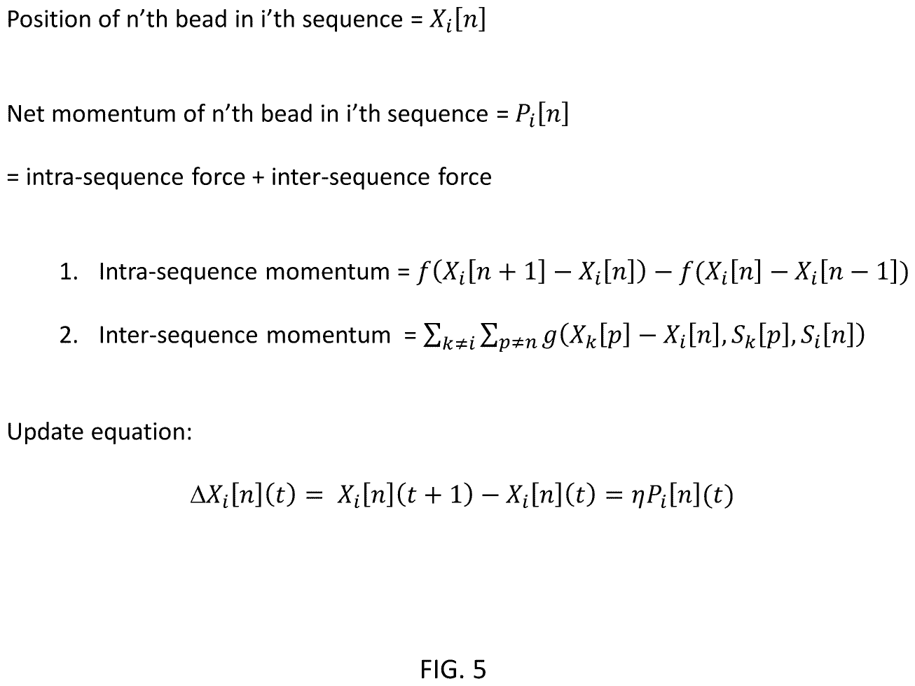

FIG. 5 depicts a system of equations to solve bead positions based on another embodiment of the invention using a mechanics momentum model where the intra-sequence and inter-sequence force functions shown in FIG. 2 and FIG. 3 are interpreted as momentum functions. In this example, velocities or increments of beads are calculated proportional to the net intra-sequence and inter-sequence momentum, and the system is a set of 1^{st} derivative nonlinear equations. η represents the update rate. In one embodiment, the update rate can be decreased as the simulation progresses to improve the accuracy of the solution.

This system of 1^{st} derivative nonlinear equations can be solved approximately in various known ways. One exemplary way is to calculate velocity from momentum and increment or decrement positions proportionally to the velocity. Eventually, all the net momenta will converge to zero and positions will be stationary.

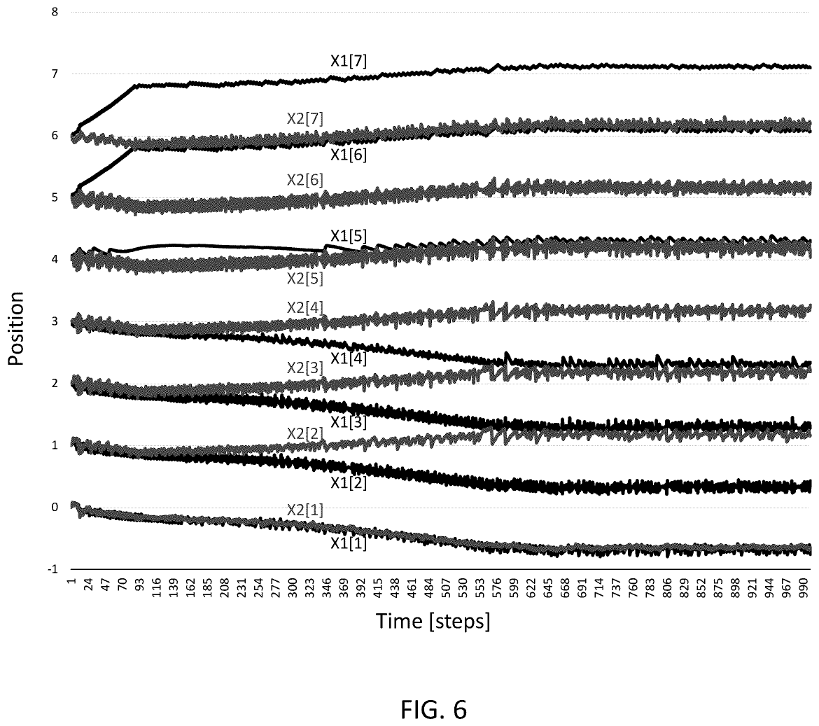

FIG. 6 depicts an example of waveforms showing transient bead positions based on one or more embodiments of the invention based on the momentum model using the piece-wise linear intra- and inter-sequence momentum and the constant update rate. The final positions of the beads constitute the state in which all the forces or momenta are balanced so that net forces or net momenta for each bead are zero.

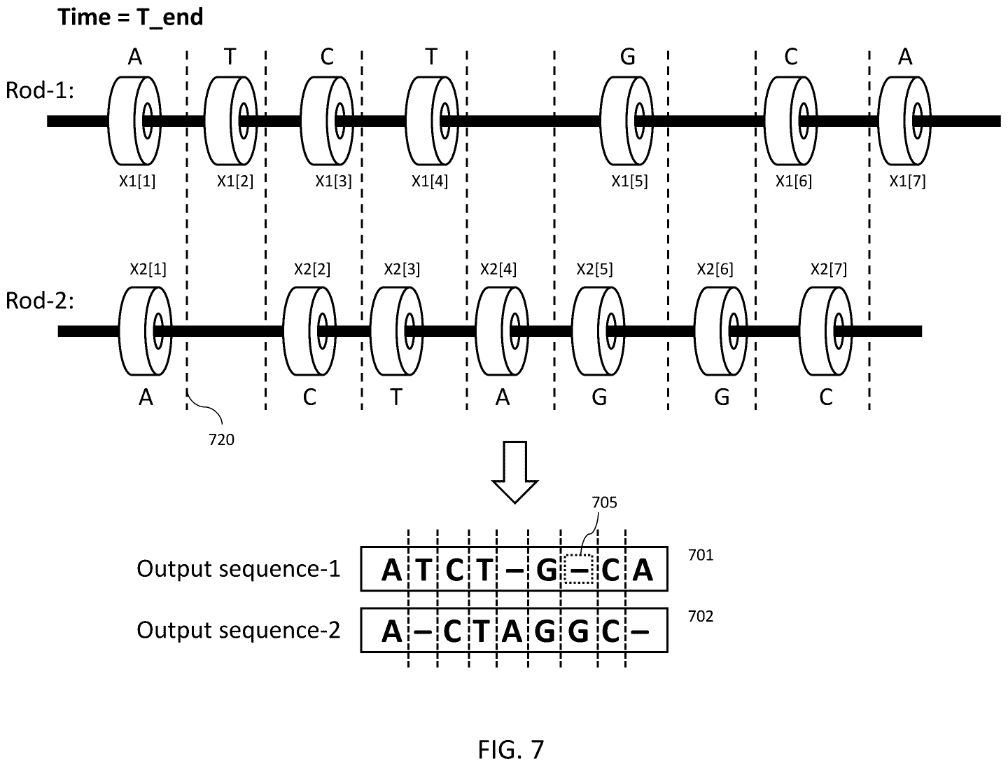

FIG. 7 depicts an example of the final positions of a solved bead model, mapping to output sequences based on the invention. The coordinates of the final positions are not integer values as described in the figure. Therefore, it is necessary to draw boundary lines (720) to group beads from different sequences together. Once all the boundary lines are determined, output sequences can be obtained by arranging beads in the same group to the same vertical column. When a gap is generated between beads, it will appear as a deletion or a bar (−) (705) in the output sequence.

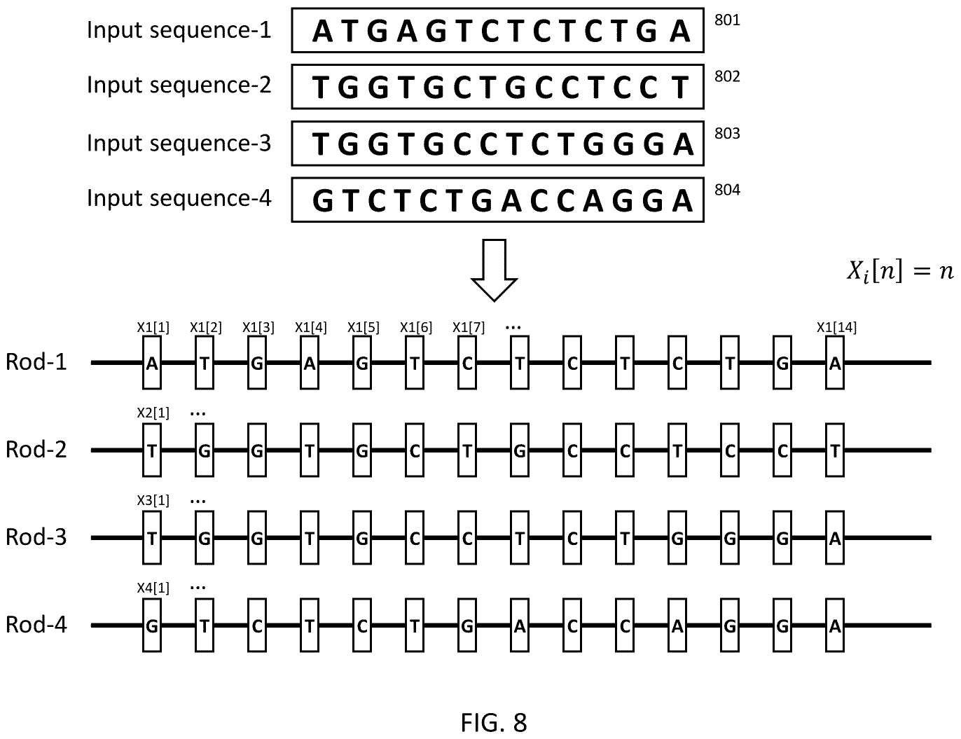

FIG. 8 depicts an example of the mapping step from four input sequences to a bead model based on the invention. The invention can be used to align any number of sequences. The same force or momentum models are applied as described previously. In the case of four sequences, each bead has two intra-sequence forces or momenta from two neighboring beads in the same sequence, and about (N−1)×(2T+1) forces or momentum where N is the total number of sequences and T is the threshold of distance in the piece-wise linear inter-sequence force function as shown in FIG. 3B (380).

The total number of forces is approximately ˜O(N²) and independent of the sequence length due to the distance threshold. The total computation load can be further reduced as the computations can be done concurrently for all the sequences and beads in parallel using 2D array or tensor operations. Therefore, with these operations, the total alignment time can be very short.

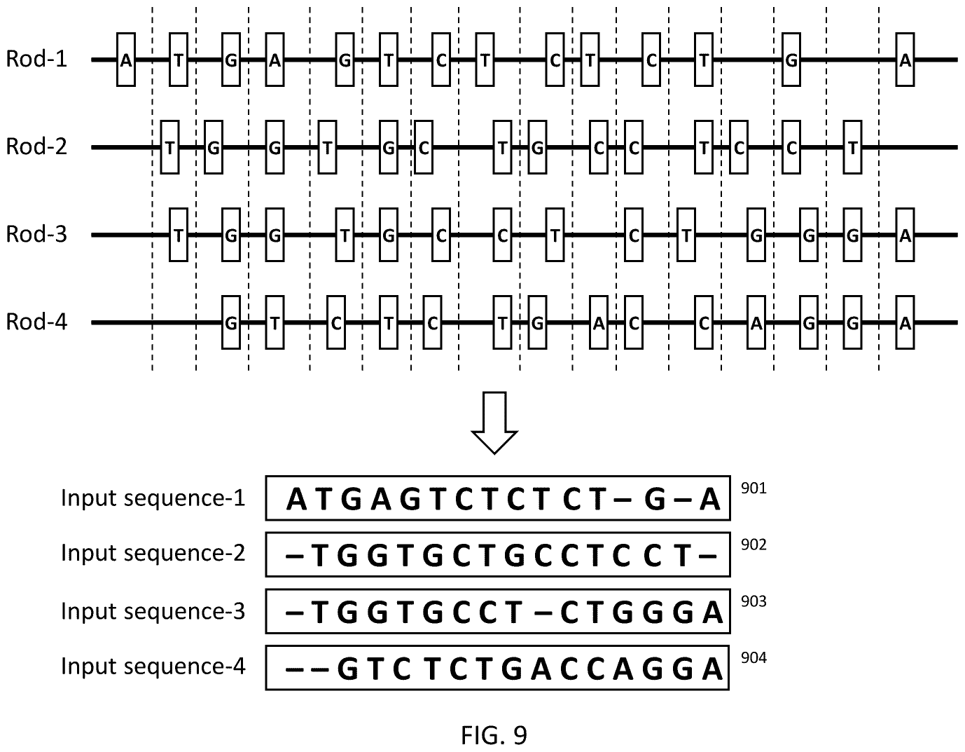

FIG. 9 depicts an example of the mapping step from the solved bead model corresponding to FIG. 8 to output sequences based on the invention. Boundary lines were drawn to group at least one and at most four beads across different sequences to convert the non-integer bead positions into the output sequences with gaps (−).

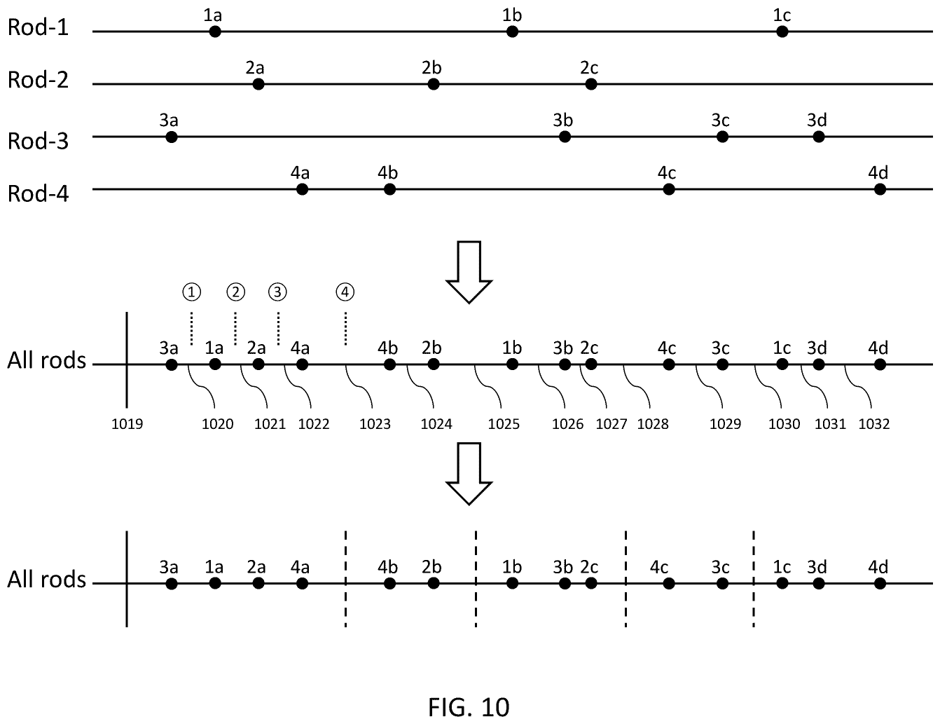

FIG. 10 depicts an exemplary quantization procedure to map the solved bead model into output sequences based on the invention. When starting from the beginning (1019), there are 4 places (\textcircled{1}, \textcircled{2}, \textcircled{3}, and \textcircled{4}) to put the first boundary line. The corresponding distances between the beads adjacent to each of the four boundary cases are 1020, 1021, 1022 and 1023. Among these four, 1023 is the longest distance, so it becomes the first boundary location. Similarly, 1025, 1028 and 1030 are chosen as the remaining boundary locations.

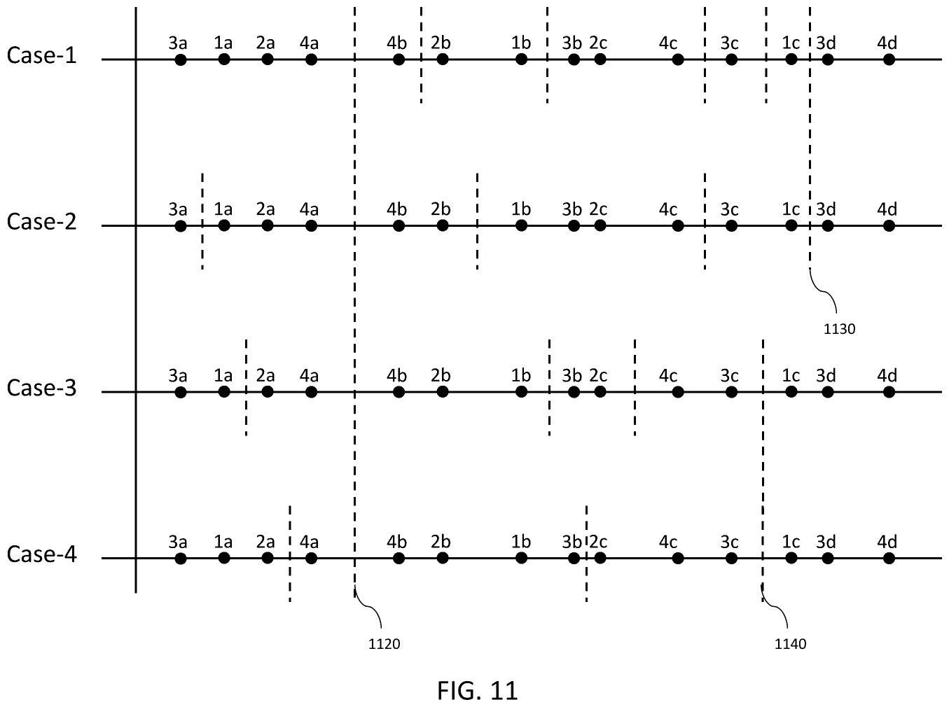

In another embodiment, the boundaries can be chosen by trying all candidates and then selecting one that results in the best alignment score. FIG. 11 shows some possible grouping cases. Although the figure does not show all possible cases, the count is relatively small. The number of cases does not keep growing because, at some point, all the different cases should converge. For example, there can only be one possible boundary like 1120 when there is no bead from any other sequence that lies between two adjacent beads in one sequence. If there is only one bead from other sequences in between two neighboring beads in the same sequence, then there are two possible boundaries, 1130 or 1140. This is due to the restriction that there can be at most one bead from a sequence between adjacent boundaries. Thus, the total number of cases is limited so that all the cases can be examined and the mapping with the best score can be identified.

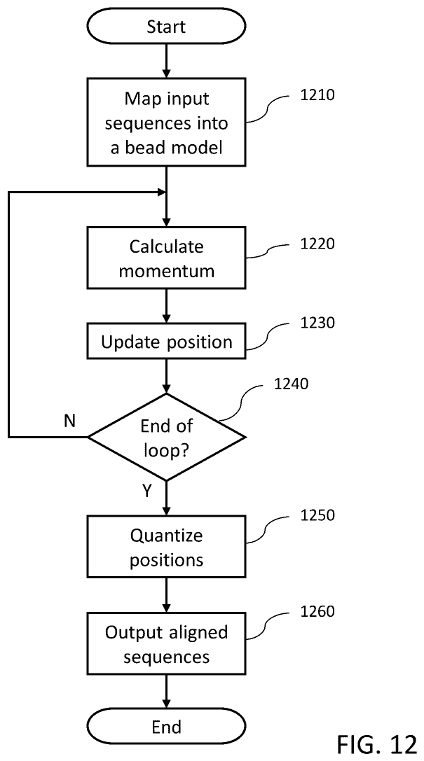

FIG. 12 depicts a flow chart that shows one embodiment of the entire procedure of multiple sequence alignment based on the invention. As the positions are updated by a small amount in each step, the position update is done in a loop. After a fixed number of executions, the loop can exit, or it can exit when the position changes are less than a certain threshold.

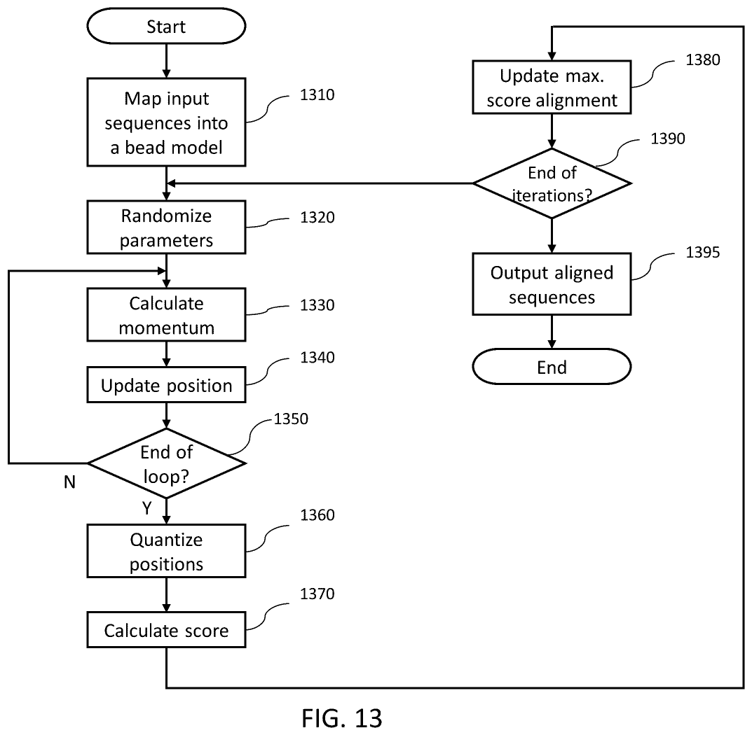

FIG. 13 depicts a flow chart that shows another embodiment of the entire procedure of multiple sequence alignment based on the invention. In this embodiment, the alignment procedure as shown in FIG. 12 is iterated multiple times but with some randomness in the initial conditions for each iteration. The randomness can be applied to the initial positions of each bead. For example, random numbers can be added to the default initial positions, i.e., Xᵢ[n]=n+rand( ). This randomization can ultimately bring about different local minima at the end of each iteration so that the best performing alignment can be chosen.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The flowchart and block diagrams in the Figures illustrate possible implementations of fabrication and/or operation methods according to various embodiments of the present invention. Various functions/operations of the method are represented in the flow diagram by blocks. In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved.

The descriptions of the various embodiments of the present invention have been presented for purposes of illustration but are not intended to be exhaustive or limited to the embodiments described. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A method for aligning two or more sequences, the method comprising:
two or more input sequences comprising plurality of base elements wherein each element belongs to one of two or more types;
assigning a series of incrementing numbers to each element in each one of said input sequences in the order each element appears in the sequence wherein said numbers represent relative positions of each element in the sequence;
defining the first interaction force among elements in the same sequence as a function of relative positions and types between elements;
defining the second interaction force among elements in different sequences as a function of relative positions and types between elements;
finding positions of each element so that net interaction forces are cancelled out at each element;
converting the positional numbers into output sequences using a predetermined conversion rule.

2. The method of claim 1, wherein:
input sequences are biological sequence such as DNA, RNA and proteins.

3. The method of claim 1, wherein:
input sequences are natural language.

4. The method of claim 1, wherein:
input sequences are financial data.

5. The method of claim 1, wherein:
finding of positions of each elements is done by iteratively updating positions according to net interaction force.

6. The method of claim 1, wherein:
the said first interaction force tends to keep constant distance to neighboring elements.

7. The method of claim 1, wherein:
the said second interaction force tends to attract elements with same kind toward each other.

8. The method of claim 1, wherein:
the said second interaction force tends to repel elements with different kind from each other.

9. A method for aligning multiple sequences, the method comprising:
multiple input sequences comprising plurality of base elements wherein each element belongs to one of two or more types;
mapping input sequences into a system of bead model, the model comprising:
plurality of parallel rods corresponding to each input sequence;
plurality of beads on each rod corresponding to each base element in corresponding input sequence;
predetermined interacting forces among beads;
finding positions of each bead on each rod so that the overall potential energy of the bead model is minimized;
mapping the bead model into output sequences.

10. The method in claim 9, wherein:
input sequences are biological sequences such as DNA, RNA or protein molecules.

11. The method in claim 9, wherein:
beads can move freely on a road they belong to, subject to predefined interacting forces.

12. The method in claim 9, wherein:
neighboring beads on a same rod tends to keep a constant distance.

13. The method in claim 9, wherein:
two beads with same type in different rods have gravity or attraction force toward each other.

14. The method in claim 9, wherein:
two beads with different types repel each other.

15. The method in claim 9, wherein:
the method is iterated with different randomization each time, so that the best result can be chosen.

16. The method in claim 9, wherein:
acceleration of each bead is proportional to net force.

17. The method in claim 9, wherein:
velocity of each bead is proportional to net force.

18. A method for aligning multiple sequences, comprising:
receiving of input sequences;
generating a series of intermediate sequence alignments, wherein:
amounts of changes in positions are smaller than default base length;
relative positions among base elements are not multiples of default base length;
quantizing relative positions among base elements to multiples of default base length.

19. The method in claim 18, wherein:
the quantization is done by grouping closest beads together based on distances.

20. The method in claim 18, wherein:
the quantization is done by trying searching optimum quantization that results in maximum alignment score.
